(19) United States
(12) Patent Application Publication
(10) Pub. No.: US 2015/0303848 A1
(43) Pub. Date: Oct. 22, 2015

(54) METHOD AND DEVICE FOR CONTROLLING AN ELECTRIC MOTOR OF A HAND MACHINE TOOL

(71) Applicant: Hilti Aktiengesellschaft, Schaan (LI)

(72) Inventor: Wolfgang Beck, Schwabsoien (DE)

(21) Appl. No.: 14/423,380

(22) PCT Filed: Aug. 21, 2013
(86) PCT No.: PCT/EP2013/067353

§ 371 Date: Feb. 23, 2015

(30) Foreign Application Priority Data
Aug. 23, 2012 (DE) 10 2012 214 977.5

(51) Int. Cl. H02P 7/29

(52) U.S. Cl. CPC H02P 7/29

(57) ABSTRACT

A method is suggested for the purpose of controlling an electric motor of a hand machine tool, wherein the electric motor is controlled by means of a pulse width modulated signal, and the carrier frequency of the pulse width modulated signal is varied during the operation of the hand machine tool.

### RELATED APPLICATIONS

The present application is filed pursuant to 37 U.S.C. 371 as a U.S. National Phase application of International Patent Application No. PCT/EP2013/067353, which was filed Aug. 21, 2013, and which claims priority to German Patent Application No. 102012214977.5, having a filing date of Aug. 23, 2012, both of which are incorporated herein by reference in their entirety.

### BACKGROUND OF THE INVENTION

The present invention relates to a method and a device for controlling an electric motor of a hand machine tool. The invention also relates to a control device for a hand machine tool, having such a device, and to such a hand machine tool, particularly an electric hand machine tool such as an electric screwdriver or a handheld drill, for example.

Electric motors in hand machine tools or hand-guided machine tools are conventionally controlled by means of pulse width modulated signals. The pulse width modulated signals conventionally have a constant carrier frequency.

Electromagnetic radiation is created as a result of the electric motor being controlled with the pulse width modulated signal. The emitted interfering power is concentrated at the base frequency of the pulse width modulated signal, and the harmonics thereof. These frequencies are generally pronounced in the entire range of interference of the hand machine tool, and are therefore critical in compliance with legal limits.

Accordingly, the problem addressed by the present invention is that of creating an improved control for an electric motor of a hand machine tool.

### BRIEF SUMMARY OF THE INVENTION

As such, the invention suggests a method for controlling an electric motor of a hand machine tool, wherein the electric motor is controlled by means of a pulse width modulated signal, and the carrier frequency of the pulse width modulated signal is varied during the operation of the hand machine tool.

As a result of the carrier frequency of the pulse width modulated signal being varied during the operation of the hand machine tool, the emitted interfering power does not concentrate at this one carrier frequency. Rather, it is distributed in a certain frequency band of a plurality of frequencies. As such, the interfering power is emitted not at a few frequencies, but rather at a plurality of frequencies. As a result, the local maximum of the emitted power at a given frequency is reduced. Consequently, it is easier to comply with legal limits.

In one embodiment, the carrier frequency of the pulse width modulated signal used to control the electric motor is particularly continuously varied during the operation of the hand machine tool. However, it is also possible that the carrier frequency of the pulse width modulated signal used to control the electric motor is sporadically, randomly, and/or arrhythmically varied during the operation of the hand machine tool. As a result of the continuous variation of the carrier frequency of the pulse width modulated signal during the operation of the hand machine tool, local maximums in the emitted interfering power are reduced and/or minimized.

In one embodiment, the carrier frequency of the pulse width modulated signal used to control the electric motor is particularly continuously varied during the operation of the hand machine tool. However, it is also possible that the carrier frequency of the pulse width modulated signal used to control the electric motor is sporadically, randomly, and/or arrhythmically varied during the operation of the hand machine tool. As a result of the continuous variation of the carrier frequency of the pulse width modulated signal during the operation of the hand machine tool, local maximums in the emitted interfering power are reduced and/or minimized.

In a further embodiment, the carrier frequency of the pulse width modulated signal used to control the electric motor is modulated during the operation of the hand machine tool by means of a certain modulation method. A plurality of known modulation methods can be used as the certain modulation method.

In a further embodiment, the carrier frequency of the pulse width modulated signal used to control the electric motor is varied during the operation of the hand machine tool in such a manner that electromagnetic radiation created as a result of the electric motor being controlled with the pulse width modulated signal is distributed over a certain frequency band about the carrier frequency or the base frequency of the pulse width modulated signal.

It is possible to distribute the emitted interfering power over a certain frequency band by varying the pulse width modulated signal. In particular, the certain frequency band can even be adjusted by the selection of the variation.

In a further embodiment, the carrier frequency of the pulse width modulated signal and the sampling rate of the pulse width modulated signal are varied in a matched relation to each other in such a manner that the rotation speed of the electric motor is kept constant.

Because the rotation speed of the electric motor can change during a variation of the carrier frequency of the pulse width modulated signal, the sampling rate of the pulse width modulated signal is preferably matched to the variation of the carrier frequency of the pulse width modulated signal, in such a manner that the rotation speed of the electric motor is kept constant.

In a further embodiment, the carrier frequency of the pulse width modulated signal and the sampling rate of the pulse width modulated signal are varied in a matched relation to each other in such a manner that the rotation speed of the electric motor is kept constant during a constant actuation of a switch of the hand machine tool which can be actuated by a user.

In a further embodiment, the electric motor is a brush motor.

In a further embodiment, the electric motor is a brushless motor.

In a further embodiment, the carrier frequency of the pulse width modulated signal used to control the electric motor is varied during the operation of the hand machine tool at a predetermined repeat rate. The predetermined repeat rate is preferably between 10 Hz and 200 Hz.

In a further embodiment, the carrier frequency of the pulse width modulated signal used to control the electric motor is varied during the operation of the hand machine tool by a predetermined value. The predetermined value is preferably 2% to 5% of the carrier frequency. The variation or change is particularly made by means of a sawtooth profile. However, it is also possible that the variation or change is made by means of a sinusoid, rectangular, or stage-arc profile.

In addition, the invention suggests a device for controlling an electric motor of a hand machine tool. The device has a supply means, a variation means, and a control means. The supply means is constructed to supply a pulse width modulated signal for the purpose of controlling the electric motor. The variation means is constructed to vary the carrier frequency of the supplied pulse width modulated signal. The control means is constructed to control the electric motor by means of the varied pulse width modulated signal.

Each of the means—supply means, variation means, and control means—can be implemented as hardware and/or as software. In the case of a hardware implementation, each means can be designed as a device or as a part of a device—for example as a computer or as a microprocessor. In the case of a software implementation, each means can be designed as a computer program product, as a function, as a routine, as part of a program code, or as an executable object.

In addition, the invention suggests a control device for a hand machine tool, wherein the control device integrates the device described above for controlling the electric motor of the hand machine tool. The device is therefore part of the control device of the hand machine tool, which is also characterized as a switch.

In addition, the invention suggests a hand machine tool having such a device. The hand machine tool is particularly an electric hand machine tool such as an electric screwdriver, a handheld drill, a chipping hammer, a rotary hammer, a cordless screwdriver, a circular saw, or a reciprocating saw.

### BRIEF DESCRIPTION OF SEVERAL VIEWS OF THE DRAWINGS

The following description explains the invention with reference to exemplary embodiments and figures, wherein:

FIG. 1 shows a schematic process diagram of a method for controlling an electric motor of a hand machine tool;

FIG. 2 shows a block process diagram of one embodiment of a device for controlling an electric motor of a hand machine tool;

FIG. 3 shows a schematic block diagram of a hand machine tool;

FIG. 4 shows a schematic block diagram of a first embodiment of the control for an electric motor of a hand machine tool; and

FIG. 5 shows a schematic block diagram of a first embodiment of a control for an electric motor of a hand machine tool.

The same or functionally-equivalent elements are indicated by the same reference numbers in the figures unless otherwise indicated.

### DETAILED DESCRIPTION OF THE INVENTION

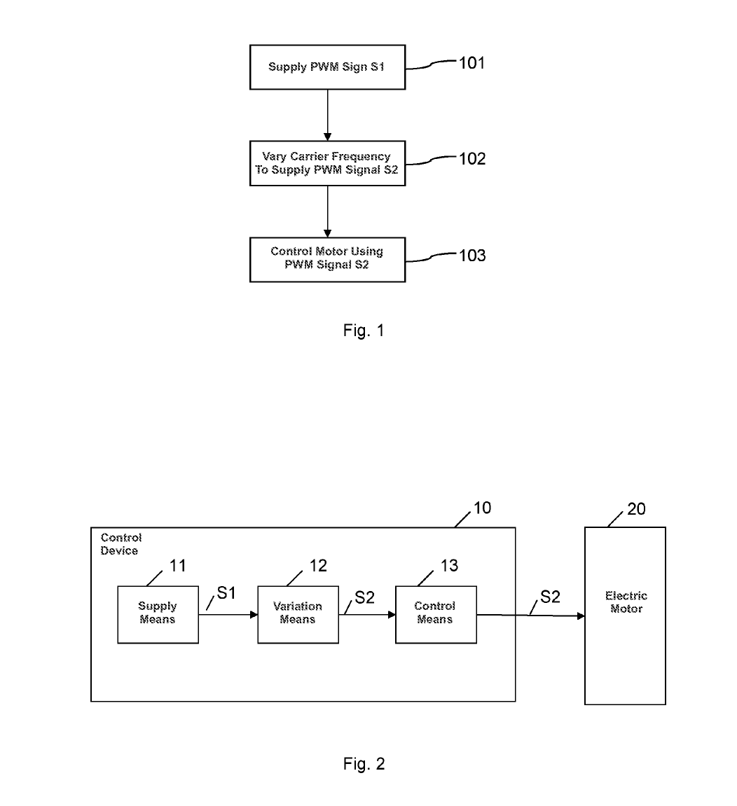

FIG. 1 shows a schematic process diagram of a method for controlling an electric motor 20 of a hand machine tool 30.

In step 101, a pulse width modulated signal S1 is supplied for the purpose of controlling the electric motor 20.

In step 102, the carrier frequency of the supplied pulse width modulated signal S1 is varied to supply a varied pulse width modulated signal S2.

In particular, the carrier frequency of the pulse width modulated signal S2 used to control the electric motor 20 is continuously varied during the operation of the hand machine tool 30. One possibility for varying the pulse width modulated signal S2 is a frequency modulation. In particular, the pulse width modulated signal S2 is modulated by means of a certain modulation method.

The carrier frequency of the pulse width modulated signal S2 used to control the electric motor 20 is preferably varied during the operation of the hand machine tool 30 in such a manner that the electromagnetic radiation emitted as a result of the control of the electric motor 20 by means of the pulse width modulated signal S2 is distributed over a certain frequency band about the carrier frequency of the pulse width modulated signal S2. As a result of the distribution of the resulting electromagnetic radiation over the plurality of the frequencies of the frequency band, the maximum of the emitted electromagnetic radiation is reduced. By way of example, the carrier frequency is 10 kHz and the frequency band is between 9.5 kHz and 10.5 kHz.

Because the variation of the frequency of the pulse width modulated signal S2 can cause an undesirable modification of the rotation speed of the electric motor 20, the frequency of the pulse width modulated signal S2 and the sampling rate of the pulse width modulated signal S2 are matched to each other in such a manner that the rotation speed of the electric motor 20 is kept constant. In this case, the rotation speed of the electric motor 20 is kept constant particularly when a switch of the hand machine tool 30 which can be actuated by a user is actuated constantly.

In step 103, the electric motor 20 is controlled by means of the varied pulse width modulated signal S2.

The suggested method can be used on hand machine tools 30 with carbon brush motors, by way of example. The method can also be used on hand machine tools 30 with brushless motors.

FIG. 2 shows a schematic block diagram of one embodiment of a device 10 for the purpose of controlling an electric motor 20 of a hand machine tool 30.

The device 10 has a supply means 11, a variation means 12, and a control means 13.

The supply means 11 is constructed to supply a pulse width modulated signal S1 for the purpose of controlling the electric motor 20. The variation means 12 receives the supplied pulse width modulated signal S1 and varies the carrier frequency thereof for the purpose of supplying a varied pulse width modulated signal S2 at the output thereof. The control means 13 receives the varied pulse width modulated signal S2 and controls the electric motor 20 by means of the same.

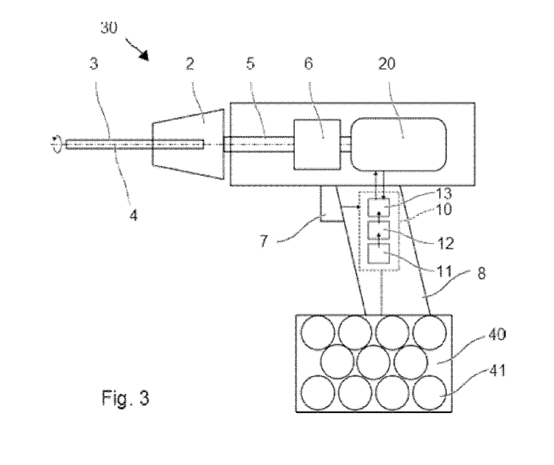

FIG. 3 shows a block diagram of a hand machine tool 30, having the device 10 in FIG. 2 and the electric motor 20, particularly integrated. FIG. 3 shows an exemplary hand machine tool 30—for example an electric screwdriver. The hand machine tool has a tool holder 2 in which a tool 3 can be inserted or attached. The tools are, by way of example, a screw head bit, a drill bit, a grinding disk, and a saw blade. An electric motor 20 drives the tool holder 2—in this case by rotation about a work axis 4, by way of example. A drive train between the tool holder 2 and the electric motor 20 can include a spindle 5, a gearing 6, and further components such as a torque coupling or an eccentric.

A user starts the hand machine tool 30 by actuating a button 7. The button 7 is preferably arranged on a hand grip 8 by means of which the user can hold and guide the hand machine tool 30. A control 10 supplies current to the electric motor 20 in response to the actuation. An exemplary current source for the hand machine tool 30 is a battery pack 40 with multiple secondary battery cells 41.

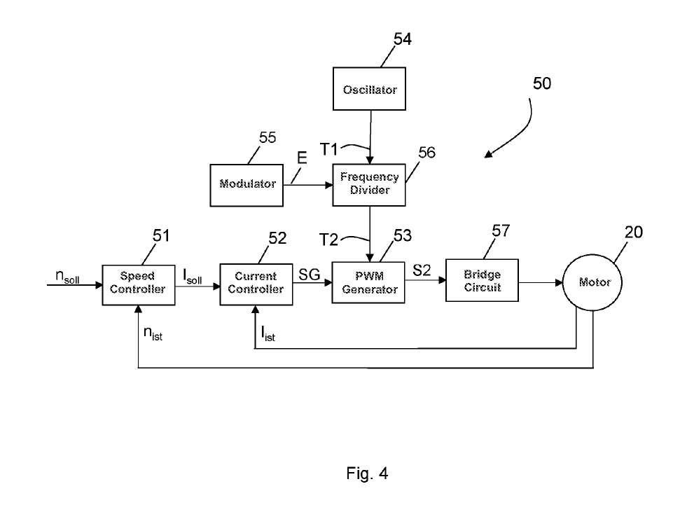

FIG. 4 shows a schematic block diagram of a first embodiment of a control 50 for an electric motor 20 of a hand machine tool 30.

The control 50 in FIG. 4 has a speed controller 51, a current controller 52, a PWM generator 53, an oscillator 54, a modulator 55, a frequency divider 56, and a motor bridge circuit 57 for the purpose of controlling the electric motor 20.

The speed controller 51 receives the momentary rotation speed nᵢₛₜ of the electric motor 20 and adjusts the same to a target rotation speed nₛₒₗₗ. The speed controller 51 outputs a target current Iₛₒₗₗ to the current controller 52 as an actuating variable. In addition, the current controller 52 also receives the momentary current Iᵢₛₜ of the electric motor 20. The current controller 52 adjusts the momentary current variable Iᵢₛₜ to the target current Iₛₒₗₗ. For this purpose, the current controller 52 outputs an actuating variable SG to the PWM generator 53.

The oscillator 54 emits a PWM pulse T1 at its output. The PWM pulse T1 is supplied to the frequency divider 56. The frequency divider 56 has an adjustable divisor which can be adjusted via an adjusting signal E. The modulator 55 supplies the adjusting signal E at its output. By way of example, the PWM pulse T1 is 64 MHz and is divided by the factor or divisor of 6400, to 10 kHz. The 10 kHz PWM frequency is then supplied to the PWM generator 53 as a varied PWM pulse T2. The PWM generator 53 has a device 10 for the purpose of generating the varied pulse width modulated signal S2. The device 10 is illustrated in detail in FIG. 2. The motor bridge circuit 57 receives a varied pulse width modulated signal S2 and controls the electric motor 20 according to the same.

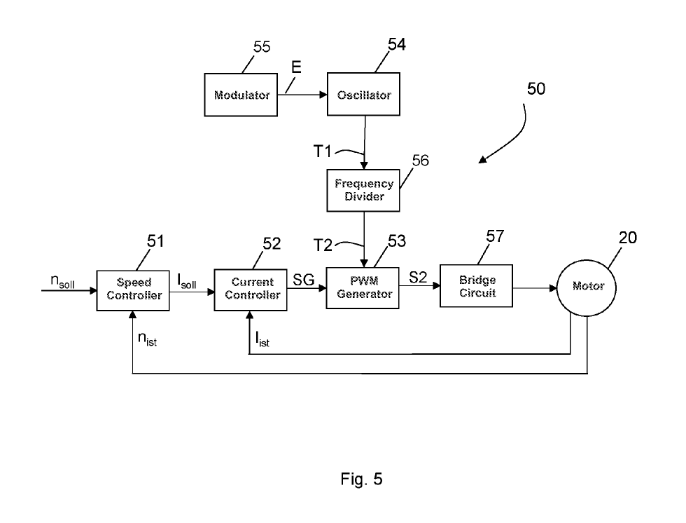

FIG. 5 shows a block diagram of a second embodiment of the control 50. The second embodiment of the control 50 differs from the first embodiment in FIG. 4 in that the adjusting signal E in FIG. 5 is not supplied to the frequency divider 56, but rather to the oscillator 54.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

What is claimed is:

1. A method for controlling an electric motor of a hand machine tool, comprising:
varying a carrier frequency of a pulse width modulated signal such that the pulse width modulated signal has a varying pulse width during operation of the hand machine tool; and
controlling the electric motor of the hand machine tool with the pulse width modulated signal having the varying pulse width during operation of the hand machine tool.

2. The method of claim 1, wherein said varying the carrier frequency comprises continuously varying the carrier frequency of the pulse width modulated signal during the operation of the hand machine tool to continuously vary the pulse width during operation of the hand machine tool.

3. The method of claim 1, wherein said varying the carrier frequency comprises modulating the carrier frequency of the pulse width modulated signal during the operation of the hand machine tool.

4. The method of claim 1, wherein said varying the carrier frequency results in electromagnetic radiation emitted by the hand machine tool to be distributed over a certain frequency band about the carrier frequency of the pulse width modulated signal.

5. The method of claim 1, further comprising matching a sampling rate of the pulse width modulated signal to the carrier frequency of the pulse width modulated signal such that a rotation speed of the electric motor is kept constant.

6. The method of claim 1, further comprising matching a sampling rate of the pulse width modulated signal to the carrier frequency of the pulse width modulated signal such that a rotation speed of the electric motor is kept constant during a constant actuation of a switch of the hand machine tool that is configured to be actuated by a user.

7. A control device for controlling an electric motor of a hand machine tool, the control device comprising:
a supply means for supplying a pulse width modulated signal for controlling the electric motor,
a variation means for varying a carrier frequency of the supplied pulse width modulated signal, for supplying a varied pulse width modulated signal, and
a control means for controlling the electric motor by the varied pulse width modulated signal.

8. A hand machine tool, comprising:
an electric motor; and
a control device configured to vary a carrier frequency of a pulse width modulated signal such that the pulse width modulated signal has a varying pulse width during operation of the hand machine tool, and control the electric motor of the hand machine tool with the pulse width modulated signal having the varying pulse width during operation of the hand machine tool.

9. The hand machine tool of claim 8, wherein the control device is further configured to continuously vary the carrier frequency of the pulse width modulated signal during the operation of the hand machine tool.

10. The hand machine tool of claim 8, wherein the control device is further configured to modulate the carrier frequency of the pulse width modulated signal during the operation of the hand machine tool.

11. The hand machine tool of claim 8, wherein the control device is further configured to vary the carrier frequency such that electromagnetic radiation emitted by the hand machine tool is distributed over a certain frequency band about the carrier frequency of the pulse width modulated signal.

12. The hand machine tool of claim 8, wherein the control device is further configured to match a sampling rate of the pulse width modulated signal to the carrier frequency of the pulse width modulated signal such that a rotation speed of the electric motor is kept constant.

13. The hand machine tool of claim 8, further comprising:
a switch configured to be actuated by a user;
wherein the control device is further configured to match a sampling rate of the pulse width modulated signal to the carrier frequency of the pulse width modulated signal such that a rotation speed of the electric motor is kept constant during a constant actuation of the switch.
